(19) United States
(12) Patent Application Publication
(10) Pub. No.: US 2025/0338016 A1
(43) Pub. Date: Oct. 30, 2025

(54) IMAGING APPRATUS AND METHOD FOR CONTROLLING IMAGING APPARATUS

(71) Applicant: Panasonic Intellectual Property Management Co., Ltd., Osaka (JP)

(72) Inventors: Koki ARIMI, Osaka (JP); Yasuhiro SHINGU, Osaka (JP); Takakazu BITO, Osaka (JP); Rikiya EJIMA, Nara (JP)

(73) Assignee: Panasonic Intellectual Property Management Co., Ltd., Osaka (JP)

(21) Appl. No.: 19/183,893

(22) Filed: Apr. 20, 2025

(30) Foreign Application Priority Data
Apr. 25, 2024 (JP) 2024-071859

(51) Int. Cl. H04N 23/67; H04N 23/55; H04N 23/63

(52) U.S. Cl. CPC H04N 23/675; H04N 23/55; H04N 23/635

(57) ABSTRACT

An imaging apparatus includes: an imaging element having an imaging surface on which light from a subject is incident; a switcher switching a state of the light between first and second states, the state being changed by an optical filter; a display device; and a processor controlling the imaging element, the switcher, and the display device. The processor determines whether the state is the first or second state. In response to determining that the state is the first state, the processor controls the display device to display first information indicative of a first range of a shooting distance that is capable of being set in the first state. In response to determining that the state is the second state, the processor controls the display device to display second information indicative of a second range of the shooting distance that is capable of being set in the second state.

### CROSS REFERENCE TO RELATED APPLICATION

This application claims benefit of priority to Japanese Patent Application 2024-071859, filed Apr. 25, 2024, the entire content of which is incorporated herein by reference.

### BACKGROUND

### Technical Field

The present disclosure relates to an imaging apparatus and a method for controlling the imaging apparatus.

### Background Art

For example, JP2023128190A discloses an imaging apparatus that can adjust the focus in the case where the focusing is not achieved when an optical filter is used. The imaging apparatus described in JP2023128190A has an imaging element, an optical filter, and a controller that adjusts the exposure. The optical filter is movable between a first position inserted into an imaging range and a second position retracted from the imaging range. The controller adjusts the exposure in the case where the focusing cannot be achieved when the optical filter is at the first position.

Recently, in the imaging apparatus, there has been a demand for displaying information regarding a settable shooting distance in response to switching the state of light using an optical filter.

### SUMMARY

An object of the present disclosure is to provide an imaging apparatus that displays information about a shooting distance that can be set in response to switching the state of light using an optical filter, and a method for controlling the imaging apparatus.

To solve the above problem, an imaging apparatus of an aspect of the present disclosure comprises:
an imaging element having an imaging surface on which light from a subject is incident;
a switcher switching a state of the light incident on the imaging surface between a first state and a second state different from the first state, the state being changed by an optical filter;
a display device displaying information; and
a processor controlling the imaging element, the switcher, and the display device, wherein
the processor determines whether the state is the first state or the second state,
in response to determining that the state is the first state, the processor controls the display device to display first information indicative of a first range of a shooting distance that is capable of being set in the first state,
in response to determining that the state is the second state, the processor controls the display device to display second information indicative of a second range of the shooting distance that is capable of being set in the second state.

A method for controlling an imaging apparatus of an aspect of the present disclosure is a control method for an imaging apparatus including an imaging element having an imaging surface on which light from a subject is incident, a switcher switching a state of the light incident on the imaging surface between a first state and a second state different from the first state, the state being changed by an optical filter, and a display device displaying information, the method comprises:
determining whether the state is the first state or the second state;
in response to determining that the state is the first state, controlling the display device to display first information indicative of a first range of a shooting distance that is capable of being set in the first state; and
in response to determining that the state is the second state, controlling the display device to display second information indicative of a second range of the shooting distance that is capable of being set in the second state.

According to the present disclosure, there can be provided an imaging apparatus that displays information about a settable shooting distance in response to switching the state of light using an optical filter, and a method for controlling the imaging apparatus.

### BRIEF DESCRIPTION OF DRAWINGS

FIG. 1 is a schematic front perspective view of an imaging apparatus according to a first embodiment of the present disclosure;

FIG. 2 is a block diagram showing a schematic configuration of the imaging apparatus according to the first embodiment of the present disclosure;

FIG. 3 is a rear perspective view of a filter module;

FIG. 4 is an exploded rear perspective view of the filter module;

FIG. 5A is a rear view of the filter module with a first filter device being at a first filtering position and a second filter device being at a second retracted position;

FIG. 5B is a rear view of the filter module with the first filter device being at a first retracted position and the second filter device being at a second filtering position;

FIG. 6 is a diagrammatic view of a detector;

FIG. 7A is a diagrammatic view of an optical path in a first optical filter;

FIG. 7B is a diagrammatic view of an optical path in a second optical filter;

FIG. 8A is a diagrammatic view for explaining adjustment of the shooting distance attributable to a focus deviation caused by switching the optical filter;

FIG. 8B is a diagrammatic view for explaining adjustment of the shooting distance attributable to a focus deviation caused by switching the optical filter;

FIG. 9 is a schematic flowchart of a control method for an imaging apparatus according to the first embodiment of the present disclosure;

FIG. 10A is a diagrammatic view showing an example of display on a liquid crystal monitor in a first state;

FIG. 10B is a diagrammatic view of an example of display on the liquid crystal monitor in a second state;

FIG. 11A is a diagrammatic view of another example of display on the liquid crystal monitor in the first state;

FIG. 11B is a diagrammatic view of another example of display on the liquid crystal monitor in the second state;

FIG. 11C is a diagrammatic view of another example of display on the liquid crystal monitor in the second state;

FIG. 12 is a flowchart of a process of determining a first range in a control method for an imaging apparatus according to a second embodiment of the present disclosure;

FIG. 13 is a flowchart of a process of determining a second range in a control method for an imaging apparatus according to a second embodiment of the present disclosure;

FIG. 14 is a schematic flowchart of a control method for an imaging apparatus according to a third embodiment of the present disclosure;

FIG. 15 is a diagrammatic view showing an example of a change in display on the liquid crystal monitor;

FIG. 16 is a schematic view for explaining an imaging apparatus according to a first variant;

FIG. 17A is a block diagram showing a schematic configuration of a first filter device according to a second variant;

FIG. 17B is a block diagram showing a schematic configuration of a second filter device according to the second variant; and

FIG. 18 is a schematic view for explaining an imaging apparatus according to a third variant.

### DETAILED DESCRIPTION

### Background to the Present Disclosure

In the imaging apparatus, the state of light incident on the imaging element is changed by using an optical filter. As an example, in the case where the optical filter is made of clear glass or neutral density (ND) glass, the light transmittance is changed. As an example, when the optical filter is a UV filter or an IR filter, ultraviolet rays or infrared rays are cut. For example, the optical filter is configured to be movable forward of the imaging surface of the imaging element, and when imaging a subject, the state of light is switched by switching the optical filter located in front of the imaging surface of the imaging element.

The optical filters have different refractive indices and/or thicknesses. For this reason, when the optical filters are switched, a focus deviation may occur attributable to the refractive index and/or thickness of the optical filters, which shifts the focusing position of the light transmitted through the optical filters. In this case, the focus is shifted, so that the shooting distance is adjusted manually or automatically to achieve the focusing.

In the case where the focus is shifted by switching the optical filter, however, the shooting distance may not be adjusted. For example, when adjusting the shooting distance by driving the focus lens, if the focus lens lies at the drive end, which is the drive limit, the focus lens cannot be moved beyond the drive end. For this reason, there may be a shooting distance range that cannot be set depending on the optical filter. In such a case, a problem takes place that the user cannot know the presence of a shooting distance range that cannot be set depending on the optical filter.

Thus, the inventor(s) conducted intensive study and found out a configuration for displaying information related to a settable shooting distance in response to switching the state of light using an optical filter, leading to the present disclosure.

Embodiments will now be described in detail with appropriate reference to the drawings. Note, however, that more detailed explanations than necessary may be omitted. For example, detailed explanations of already well-known matters and duplicate explanations for substantially the same configurations may be omitted. This is to avoid the following description becoming unnecessarily redundant and to facilitate understanding by those skilled in the art.

The present disclosure provides the accompanying drawings and the following description in order that those skilled in the art fully understand the present disclosure, but do not intend to thereby limit the subject matter defined in the appended claims.

Hereinafter, an imaging apparatus and a method for controlling the imaging apparatus according to a first embodiment of the present disclosure will be described with reference to the drawings.

### First Embodiment

### (Overall Configuration)

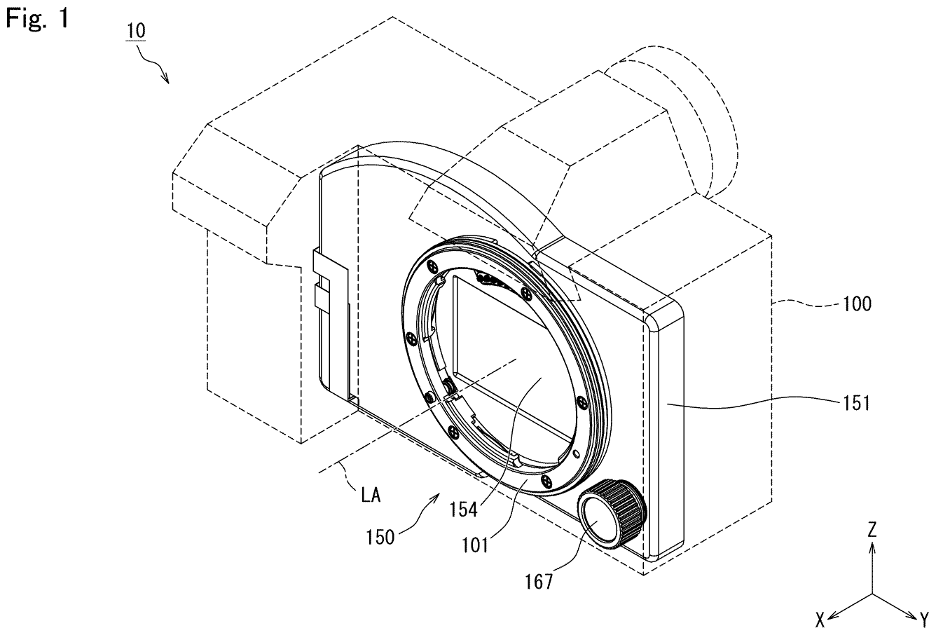

FIG. 1 is a schematic front perspective view of an imaging apparatus according to a first embodiment of the present disclosure. Note that the X-Y-Z Cartesian coordinate system shown in the figure is for facilitating understanding of the embodiment of the present disclosure, and does not limit the embodiment of the present disclosure. The X-axis direction is the front-rear direction of the imaging apparatus, the Y-axis direction is the left-right direction, and the Z-axis direction is the height direction. Note that the side on which a subject is present during imaging is defined as the front side of the imaging apparatus.

As shown in FIG. 1, an imaging apparatus 10 according to the first embodiment of the present disclosure is a so-called digital single-lens camera. The imaging apparatus 10 includes a camera body 100. The camera body 100 is provided with a body mount 101. An interchangeable lens 200 is detachably attached to the body mount 101. The imaging apparatus 10 also includes a filter module 150 that switches the state of light.

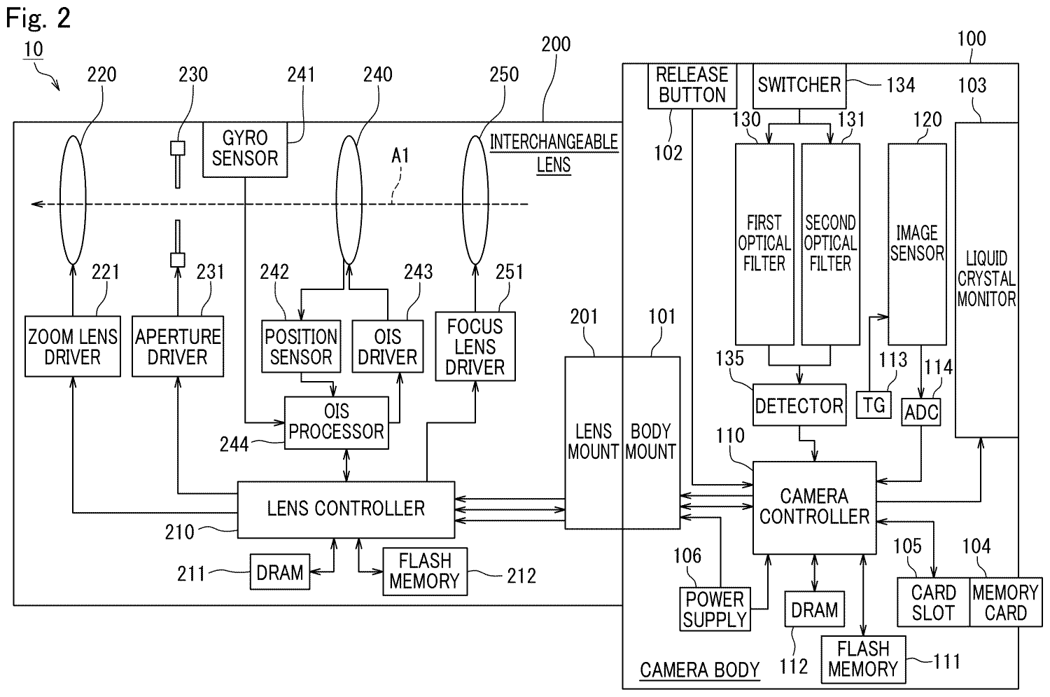

FIG. 2 is a block diagram showing a schematic configuration of the imaging apparatus according to the first embodiment of the present disclosure.

As shown in FIG. 2, the camera body 100 includes a camera controller 110, a flash memory 111, and an image sensor 120 which is an example of an imaging element.

The camera controller 110 controls the overall operation of the imaging apparatus 10 by controlling components such as the image sensor 120 in response to instructions from various buttons such as a release button 102 and from various operating members. Specifically, the camera controller 110 transmits a vertical synchronization signal to a timing generator (TG) 113 and generates an exposure synchronization signal based on the vertical synchronization signal. The camera controller 110 also periodically transmits the generated exposure synchronization signal to the interchangeable lens 200 via the body mount 101. In this manner, the camera controller 110 controls the interchangeable lens 200 so as to synchronize with the exposure timing.

The camera controller 110 includes a processor, and the processor executes instructions to implement a predetermined function. For example, the camera controller 110 may be implemented by various processors such as a CPU, an MPU, a GPU, a DSU, an FPGA, and an ASIC. The processor may be configured with a dedicated electronic circuit designed to implement a predetermined function. The camera controller 110 may also be configured with one or more processors. The camera controller 110 uses the DRAM 112 as a working memory during control operations and image processing operations.

The flash memory 111 stores instructions executed by the camera controller 110. For example, the flash memory 111 stores programs, parameters, data, etc. used when controlling the camera controller 110. The camera controller 110 executes various control operations based on the programs, parameters, data, etc. stored in the flash memory 111.

The image sensor 120 captures an image of a subject incident through the interchangeable lens 200 to generate image data. The image sensor 120 has an imaging surface on which light from the subject image is incident. The image data generated by the image sensor 120 is digitized by an analog-to-digital conversion circuit (ADC) 114. The image data digitized by the analog-to-digital conversion circuit is subjected to predetermined image processing by the camera controller 110. The image data processed by the camera controller 110 is displayed on a liquid crystal monitor 103, which is an example of a display device disposed on the rear surface of the camera body 100. The image sensor 120 is, for example, a charge coupled device (CCD) sensor or a complementary metal oxide semiconductor (CMOS) sensor.

The image sensor 120 operates at a timing controlled by the timing generator 113. The operations of the image sensor 120 include a still image capturing operation, a through image capturing operation, a data transfer operation, an electronic shutter operation, and the like.

The camera body 100 includes a card slot 105 to which a memory card 104 is detachably connected, and a power supply 106.

The card slot 105 is configured to be capable of electrically and mechanically connecting the memory card 104. The memory card 104 is an external memory including a storage element such as a flash memory inside. The memory card 104 stores various data including image data processed by the camera controller 110. The various data stored in the memory card 104 is read out by the camera controller 110 via the card slot 105, for example, and displayed on the liquid crystal monitor 103.

The power supply 106 supplies power for driving the imaging apparatus 10. The power supply 106 may be, for example, a dry cell or a rechargeable battery, or may supply power supplied from outside via a power cord to the imaging apparatus 10. When the power supply 106 is turned on, the camera controller 110 supplies power to each part of the camera body 100. The camera controller 110 also supplies power to the interchangeable lens 200 via the body mount 101. The power is supplied to each part of the interchangeable lens 200 by a lens controller 210, which will be described later.

The body mount 101 is configured to be mechanically and electrically connectable to a lens mount 201 disposed on the interchangeable lens 200. The body mount 101 is also configured to be able to transmit and receive data between the camera body 100 and the interchangeable lens 200 via the lens mount 201. The body mount 101 transmits an exposure synchronization signal and other control signals received from the camera controller 110 to the lens controller 210 via the lens mount 201. The body mount 101 also transmits signals received from the lens controller 210 via the lens mount 201 to the camera controller 110.

The camera body 100 includes a first optical filter 130, a second optical filter 131, a switcher 134, and a detector 135. In this embodiment, the first optical filter 130, the second optical filter 131, the switcher 134, and the detector 135 configure the filter module 150 in FIG. 1.

The first optical filter 130 and the second optical filter 131 are filters used to change the state of light. Specifically, when capturing an image of a subject, the first optical filter 130 and the second optical filter 131 are switched between for use to switch the state of light incident on an imaging surface 120a of the image sensor 120. In this embodiment, the state of light implemented by using the first optical filter 130 is referred to as a first state, and the state of light implemented by using the second optical filter 131 is referred to as a second state.

In this embodiment, as an example, the first optical filter 130 and the second optical filter 131 are filters used to change the transmittance of light. For example, the first optical filter 130 is clear glass, and the second optical filter 131 is an ND filter.

The switcher 134 switches a state of light incident on the imaging surface 120a of the image sensor 120 between the first state and the second state different from the first state by changing the state using the first optical filter 130 or the second optical filter 131. That is, the switcher 134 switches the state between the first state and the second state by switching between the first optical filter 130 and the second optical filter 131.

The switcher 134 includes a driver that moves the first and second optical filters 130 and 131 between a filtering position and a retracted position. The filtering position is a position where the first optical filter 130 or the second optical filter 131 is disposed in front of the imaging surface of the image sensor 120, and light before reaching the imaging surface passes through the first optical filter 130 or the second optical filter 131. The retracted position is a position where the first optical filter 130 or the second optical filter 131 is removed from in front of the imaging surface.

In this embodiment, the driver rotates the first optical filter 130 between a first filtering position and a first retracted position, and rotates the second optical filter 131 between a second filtering position and a second retracted position. In the first state, the first optical filter 130 is disposed at the first filtering position, and the second optical filter 131 is disposed at the second retracted position. In the second state, the first optical filter 130 is disposed at the first retracted position, and the second optical filter 131 is disposed at the second filtering position.

The detector 135 detects the first state and the second state. For example, the detector 135 detects the first and second states based on the positions of the first and second optical filters 130 and 131. The detector 135 detects the first state when the first optical filter 130 is disposed at the first filtering position. The detector 135 detects the second state when the second optical filter 131 is disposed at the second filtering position.

The flash memory 111 stores a first range of shooting distances that can be set in the first state and a second range of shooting distances that can be set in the second state. The settable shooting distances refer to shooting distances at which the focus can be adjusted by driving the lens or the image sensor through a user operation or an automatic program.

The first range and the second range are set in advance during the manufacturing stage of the imaging apparatus 10. For example, the first range is set based on the focus deviation caused by the first optical filter 130. Moreover, the second range is set based on the focus deviation caused by the second optical filter 131.

In this embodiment, the first optical filter 130 is clear glass, and the second optical filter 131 is an ND filter. For example, the second optical filter 131 has a larger refractive index and a larger thickness than the first optical filter 130. Therefore, the second optical filter 131 is more likely to be defocused than the first optical filter 130. As a result, the second range is set to be smaller than the first range.

The interchangeable lens 200 includes an optical system OP and the lens controller 210.

The optical system OP is a combination of optical members for forming a subject image on the imaging surface of the image sensor 120. The optical system OP includes a zoom lens 220, an aperture 230, an optical image stabilizer (OIS) lens 240, and a focus lens 250.

The zoom lens 220 is a lens for changing the magnification of a subject image formed by the optical system OP. The zoom lens 220 is composed of one or more lenses. The zoom lens 220 is moved forward and backward in the optical axis direction A1 by a zoom lens driver 221. The zoom lens driver 221 includes a zoom ring or the like that can be operated by the user, transmits the operation by the user to the zoom lens 220, and moves the zoom lens 220 forward and backward in the optical axis direction A1.

The aperture 230 adjusts the amount of light incident from the subject onto the imaging surface of the image sensor 120. The aperture 230 adjusts the amount of light incident onto the imaging surface by changing the size of a through hole through which the light passes. The aperture 230 is driven by an aperture driver 231.

The OIS lens 240 is a lens for correcting blur of a subject image formed by the optical system of the interchangeable lens 200. The OIS lens 240 is composed of one or more lenses. The OIS lens 240 reduces blur of the subject image on the image sensor 120 by moving in a direction that offsets the shake of the imaging apparatus 10. The function of correcting camera shake by moving the OIS lens 240 is called the “OIS function”. The interchangeable lens 200 includes a gyro sensor 241, a position sensor 242, an OIS driver 243, and an OIS processor 244 as components for implementing the OIS function.

The gyro sensor 241 is a detector that detects the shake of the interchangeable lens 200. The position sensor 242 is a sensor that detects the position of the OIS lens 240 in a plane perpendicular to the optical axis direction A1. The position sensor 242 can be implemented, for example, by a magnet and a Hall element. The OIS driver 243 moves the OIS lens 240. The OIS driver 243 can be implemented, for example, by a magnet and a flat coil. The OIS processor 244 controls the OIS driver 243 based on the detection results of the gyro sensor 241 and the position sensor 242 to perform shake correction processing that moves the OIS lens 240 in a plane perpendicular to the optical axis direction A1 so as to offset the shake of the interchangeable lens 200.

The focus lens 250 is a lens for changing the focus state of the subject image formed on the image sensor 120 by the optical system OP. The focus lens 250 is composed of one or more lenses. The focus lens 250 is moved in the optical axis direction A1 by a focus lens driver 251. The focus lens driver 251 includes a focus ring that can be operated by the user and a driver that implements an autofocus function, and transmits the operation by the user to the focus lens 250, and moves the focus lens 250 forward and backward in the optical axis direction A1.

The zoom lens driver 221, the aperture driver 231, the OIS processor 244, and the focus lens driver 251 are controlled by the lens controller 210.

The lens controller 210 controls the overall operation of the interchangeable lens 200 in response to control from the camera controller 110. The lens controller 210 includes a processor, and the processor executes instructions to implement a predetermined function. For example, the lens controller 210 may be implemented by various processors such as a CPU, MPU, GPU, DSU, FPGA, ASIC, etc. The processor may be composed of a dedicated electronic circuit designed to implement a predetermined function. The lens controller 210 may also be composed of one or more processors.

Furthermore, the lens controller 210 controls the zoom lens driver 221, the aperture driver 231, the OIS processor 244, and the focus lens driver 251 based on the information stored in a DRAM 211 and a flash memory 212. When controlling the zoom lens driver 221, the aperture driver 231, the OIS processor 244, and the focus lens driver 251, the lens controller 210 uses the DRAM 211 as a work memory.

The flash memory 212 stores programs, parameters, lens data, etc. used when controlling the lens controller 210. Here, the lens data includes the lens name, lens ID, serial number, F-score (aperture value), lens focal length, lens shooting distance, presence or absence of an electric zoom function, resolution characteristic information, characteristic values specific to the interchangeable lens 200, etc. The lens data stored in the flash memory 212 is transmitted to the camera controller 110 by the lens controller 210. The camera controller 110 executes various control operations based on the lens data.

### (About Filter Module Configuration)

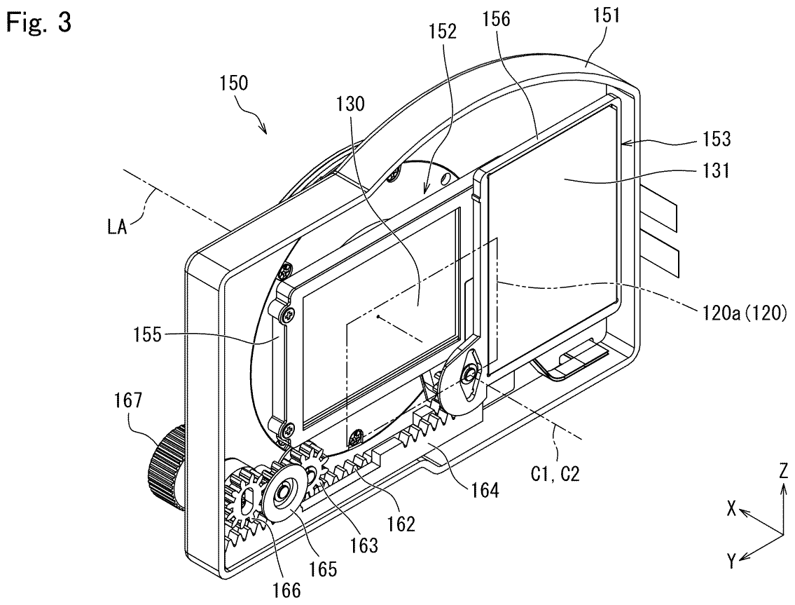

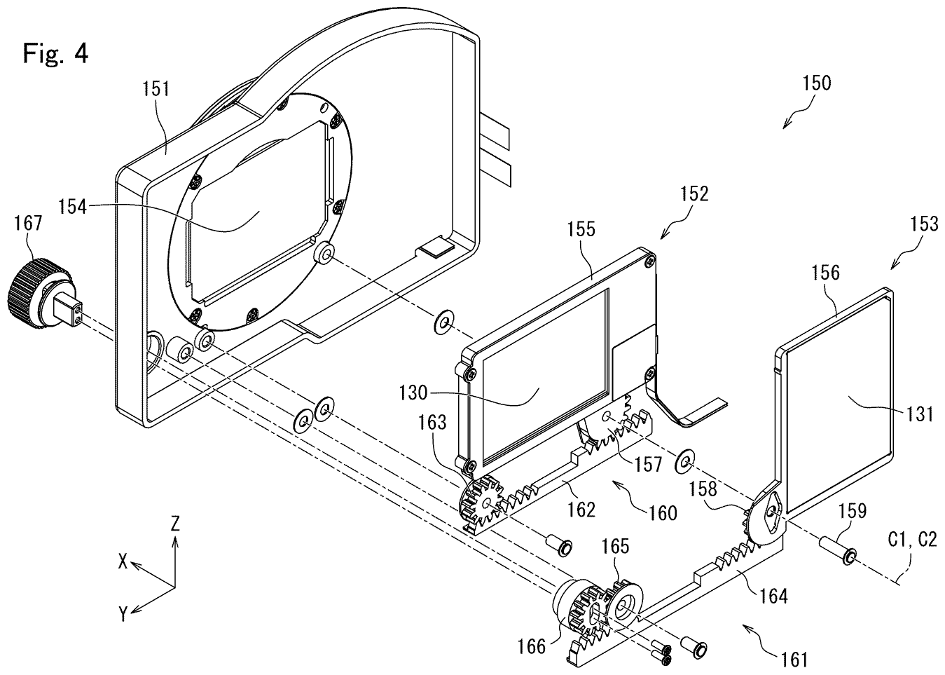

The filter module 150 will be described with reference to FIGS. 3 and 4.

FIGS. 3 and 4 are rear perspective and exploded rear perspective views, respectively, of the filter module.

As shown in FIGS. 3 and 4, in this embodiment, the filter module 150 has a housing 151, a first filter device 152, and a second filter device 153.

The housing 151 is made of a metal material such as aluminum die casting, and supports the first and second filter devices 152 and 153. In this embodiment, the housing 151 also includes a protective glass 154 through which light from a subject passes.

As shown in FIG. 3, the image sensor 120 faces the protective glass 154 at a distance in the extension direction of the optical axis LA of the imaging apparatus 10 (i.e., the front-rear direction (X-axis direction) of the imaging apparatus 10), and has the imaging surface 120a on which light from a subject is incident. The optical axis LA is perpendicular to the imaging surface 120a of the image sensor 120 and passes through the center of the rectangular imaging surface 120a.

In this embodiment, as shown in FIGS. 3 and 4, the first filter device 152 includes a first optical filter 130 and a first frame structure 155 that supports the outer periphery of the first optical filter 130. The second filter device 153 includes a second optical filter 131 and a second frame structure 156 that supports the outer periphery of the second optical filter 131.

In this embodiment, the first and second optical filters 130 and 131 are rectangular in shape, similar to the imaging surface 120a of the image sensor 120.

The first filter device 152, i.e., the first frame structure 155 supporting the first optical filter 130, is supported by the housing 151 so as to be rotatable about a first rotation center line C1 extending in the front-rear direction (X-axis direction) of the image capture device 10. The second filter device 153, i.e., the second frame structure 156 supporting the second optical filter 131, is supported by the housing 151 so as to be rotatable about a second rotation center line C2 extending in the front-rear direction of the image capture device 10.

In this embodiment, as shown in FIGS. 3 and 4, the first and second rotation center lines C1 and C2 are aligned on the same line. Therefore, the first filter device 152 rotates forward relative to the second filter device 153. Since the first and second rotation center lines C1 and C2 are aligned on the same line, a support shaft 159 that rotatably supports the first and second filter devices 152 and 153 can be shared.

As shown in FIG. 4, the filter module 150 has a first driver 160 that rotates the first filter device 152 about the first rotation center line C1 and a second driver 161 that rotates the second filter device 153 about the second rotation center line C2. The first driver 160 and the second driver 161 configure the switcher 134.

In this embodiment, the first and second drivers 160 and 161 are so-called rack-and-pinion mechanisms.

The first driver 160 includes a first rack 162 extending in the left-right direction (Y-axis direction) of the imaging apparatus 10 and supported by the housing 151 so as to be movable in the left-right direction, and a first drive gear 163 that engages with the first rack 162 to move it in the left-right direction. The first rack 162 engages with a pinion part 157 formed on the first frame structure 155 of the first filter device 152. The first rack 162 moves in the left-right direction due to the rotation of the first drive gear 163, and the pinion part 157 rotates about the first rotation center line C1. As a result, the first filter device 152 rotates about the first rotation center line C1.

The second driver 161 includes a second rack 164 that extends in the left-right direction (Y-axis direction) of the imaging apparatus 10 and is supported by the housing 151 so as to be movable in the left-right direction, and a second drive gear 165 that engages with the second rack 164 to move it in the left-right direction. The second rack 164 extends rearward and parallel to the first rack 162. The second rack 164 also engages with a pinion part 158 formed on the second frame structure 156 of the second filter device 153. The second rack 164 moves in the left-right direction due to the rotation of the second drive gear 165, and the pinion part 157 rotates around the second rotation center line C2. As a result, the second filter device 153 rotates around the second rotation center line C2.

In this manner, the first filter device 152 rotates about the first rotation center line C1 between the first filtering position and the first retracted position by the first driver 160. Also, the second filter device 153 rotates about the second rotation center line C2 between the second filtering position and the second retracted position by the second driver 161.

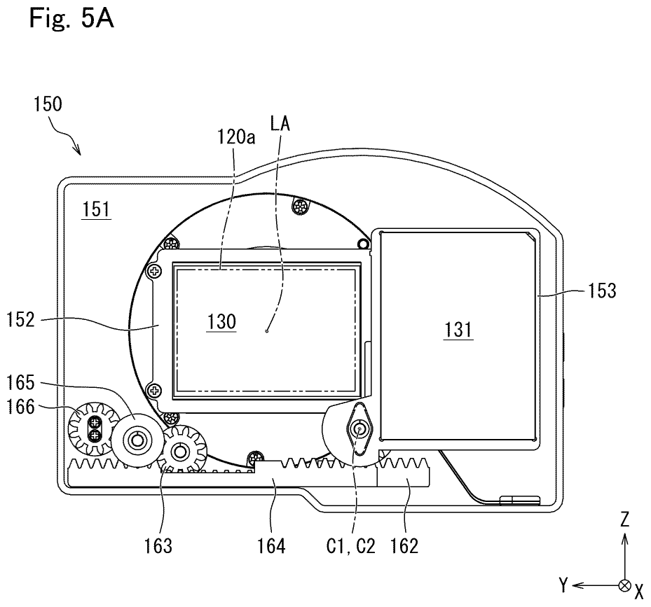

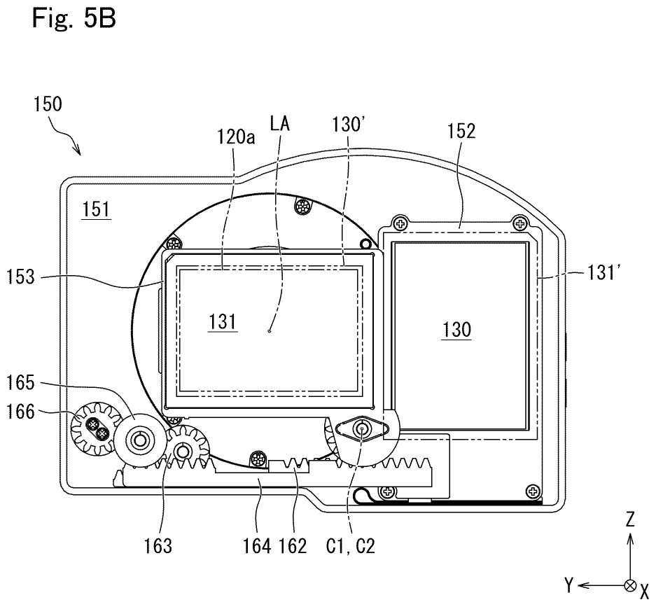

FIG. 5A is a rear view of the filter module in a state where the first filter device 152 is disposed at the first filtering position and the second filter device 153 is located in the second retracted position. FIG. 5B is a rear view of the filter module in a state where the first filter device 152 is located in the first retracted position and the second filter device 153 is disposed at the second filtering position.

As shown in FIG. 5A, the first filter device 152 is rotated by the first driver 160 and disposed at the first filtering position. Specifically, when the first filter device 152 is disposed at the first filtering position, the first optical filter 130 is disposed in front of the imaging surface 120a of the image sensor 120. As a result, light from the subject that has passed through the protective glass 154 and has not yet reached the imaging surface 120a passes through the first optical filter 130. As a result, the light from the subject that has been filtered by the first optical filter 130 is incident on the imaging surface 120a.

As shown in FIG. 5B, the first filter device 152 is rotated by the first driver 160 and disposed in the first retracted position. Specifically, the first filter device 152 retracts to a position that is off the front of the imaging surface 120a of the image sensor 120 as the first retracted position. In this embodiment, the first filter device 152 retracts from the front of the imaging surface 120a to the left (when viewed from the front of the imaging apparatus 10). This allows light from the subject to be incident on the imaging surface 120a without being obstructed by the first filter device 152, i.e., without passing through the first optical filter 130.

As shown in FIG. 5B, the second filter device 153 is rotated by the second driver 161 and disposed at the second filtering position. Specifically, when the second filter device 153 is disposed at the second filtering position, the second optical filter 131 is present in front of the imaging surface 120a of the image sensor 120. Light from the subject before passing through the protective glass 154 and reaching the imaging surface 120a passes through the second optical filter 131. As a result, the light from the subject filtered by the second optical filter 131 is incident on the imaging surface 120a. Note that the second filtering position is disposed rearward of the first filtering position.

In this embodiment, as shown in FIG. 5A, the second filter device 153 is rotated by the second driver 161 and disposed at the second retracted position. Specifically, the second filter device 153 retracts to a position that is off the front of the imaging surface 120a of the image sensor 120 as the second retracted position. In this embodiment, the second filter device 153 retracts from the front of the imaging surface 120a to the left (when viewed from the front of the imaging apparatus 10). This allows light from the subject to be incident on the imaging surface 120a without being obstructed by the second filter device 153, i.e., without passing through the second optical filter 131. The second retracted position is located rearward of the first retracted position.

In this embodiment, as shown in FIG. 5B, the first filter device 152 is rotated substantially 90 degrees around the first rotation center line C1 by the first driver 160. Therefore, the positional relationship between the first filtering position and the first retracted position is such that the first filter device 152 disposed at one of the first filtering position and the first retracted position is disposed at the other when rotated 90 degrees. As a result, the attitude (two-dot chain line) of the first optical filter 130 (130′) of the first filter device 152 disposed at the first filtering position differs by 90 degrees from the attitude (solid line) of the first optical filter 130 when disposed at the first retracted position. That is, the longitudinal direction of the first optical filter 130 changes from the left-right direction (Y-axis direction) of the imaging apparatus 10 to the height direction (Z-axis direction).

Furthermore, the first rotation center line C1 of the first filter device 152 is positioned so that the first optical filter 130 (130′) disposed at the first filtering position and the first optical filter 130 disposed at the first retracted position are as adjacent as possible without overlapping with each other. For example, in this embodiment, the first rotation center line C1 is positioned near the lower left corner of the first optical filter 130 (130′) when disposed at the first filtering position (when viewed from the front of the imaging apparatus 10) without passing through the first optical filter 130.

Such a first rotation center line C1 can reduce the movement range of the first optical filter 130, i.e., the first filter device 152, compared to the case where the first optical filter 130 moves parallel to the left-right direction (Y-axis direction) of the imaging apparatus 10. As a result, it is possible to prevent the imaging apparatus 10 from becoming larger, particularly in the left-right direction. In addition, it is possible to prevent a deterioration in the design of the imaging apparatus 10 due to the increase in size in the left-right direction.

In this embodiment, as shown in FIG. 5B, the second filter device 153 is rotated substantially 90 degrees around the second rotation center line C2 by the second driver 161. Therefore, the positional relationship between the second filtering position and the second retracted position is such that the second filter device 153 disposed at one of the second filtering position and the second retracted position is disposed at the other when rotated 90 degrees. As a result, the attitude (solid line) of the second optical filter 131 of the second filter device 153 disposed at the second filtering position differs by 90 degrees from the attitude (two-dot chain line) of the second optical filter 131 (131′) when disposed at the second retracted position. That is, the longitudinal direction of the second optical filter 131 changes from the left-right direction (Y-axis direction) of the imaging apparatus 10 to the height direction (Z-axis direction).

Furthermore, the second rotation center line C2 of the second filter device 153 is positioned so that the second optical filter 131 disposed at the second filtering position and the second optical filter 131 (131′) disposed at the second retracted position are as adjacent as possible without overlapping with each other. For example, in this embodiment, the second rotation center line C2 is positioned near the lower left corner of the second optical filter 131 when disposed at the second filtering position (when viewed from the front of the imaging apparatus 10) without passing through the second optical filter 131.

Such a second rotation center line C2 can reduce the movement range of the second optical filter 131, i.e., the second filter device 153, compared to the case where the second optical filter 131 moves parallel to the left-right direction (Y-axis direction) of the imaging apparatus 10. As a result, it is possible to prevent the imaging apparatus 10 from becoming larger, particularly in the left-right direction. In addition, it is possible to prevent a deterioration in the design of the imaging apparatus 10 due to the increase in size in the left-right direction.

The second filter device 153 also rotates substantially 90 degrees, like the first filter device 152, and therefore does not significantly affect the design of the imaging apparatus 10, compared to when it moves parallel to the left-right direction (Y-axis direction) or height direction (Z-axis direction) of the imaging apparatus 10.

In this embodiment, the rotational movement of first filter device 152 by first driver 160 and the rotational movement of second filter device 153 by second driver 161 are synchronized.

Specifically, as shown in FIG. 5A, when the first filter device 152 is disposed at the first filtering position (i.e., a position in front of the imaging surface 120a of the image sensor 120), the rotational movements of the first and second filter devices 152 and 153 are synchronized so that the second filter device 153 is disposed at the second retracted position (i.e., a position away from the front of the imaging surface 120a). Also, as shown in FIG. 5B, when the first filter device 152 is disposed at the first retracted position, the rotational movements of the first and second filter devices 152 and 153 are synchronized so that the second filter device 153 is disposed at the second filtering position. To achieve this, the first driver 160 and the second driver 161 are synchronized.

In this embodiment, as shown in FIGS. 3 and 4, the first drive gear 163 of the first driver 160 and a second drive gear 165 of the second driver 161 are engaged with each other. In addition, the second drive gear 165 is engaged with a power transmission gear 166 which is a power supply that supplies power to the first driver 160 and the second driver 161. This power transmission gear 166 is disposed on the front surface of the imaging apparatus 10, and is connected to a rotation knob 167 which is rotated by the user.

When the user rotates the rotation knob 167 from the state shown in FIG. 5A, the power transmission gear 166 rotates, and thereby the first drive gear 163 and the second drive gear 165 rotate synchronously. As a result, the first rack 162 engaged with the first drive gear 163 moves to the right (when viewed from the front of the imaging apparatus 10), and the second rack 164 engaged with the second drive gear 165 moves in the opposite direction, i.e., to the left. The first rack 162 and the second rack 164 move in the opposite directions, causing the first filter device 152 and the second filter device 153 to rotate in opposite directions.

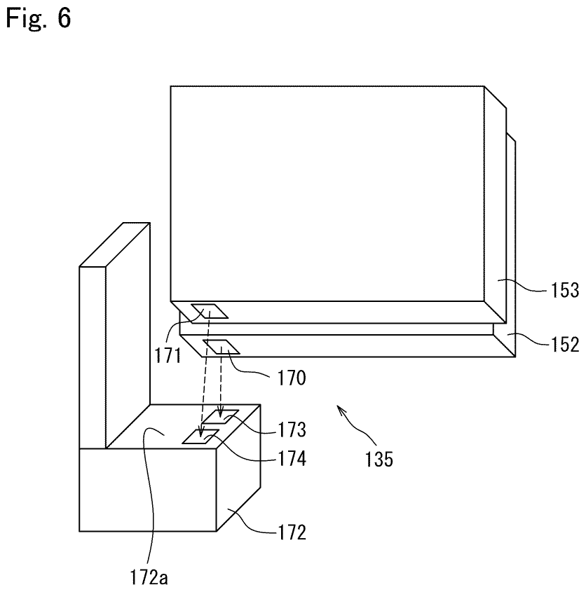

FIG. 6 is a diagrammatic view of the detector.

As shown in FIG. 6, the detector 135 includes first to fourth electrical contact portions 170, 171, 173, and 174. The first filter device 152 and the second filter device 153 are provided with the first electrical contact portion 170 and the second electrical contact portion 171, respectively. Specifically, the first electrical contact portion 170 is disposed on the bottom surface of the first frame structure 155. The second electrical contact portion 171 is disposed on the bottom surface of the second frame structure 156.

The filter module 150 also includes a contact base 172 having a contact surface 172a that contacts the first and second filter devices 152 and 153. The third electrical contact portion 173 and the fourth electrical contact portion 174 are disposed on the contact surface 172a of the contact base 172. The third electrical contact portion 173 is in contact with and electrically connected to the first electrical contact portion 170 when the first filter device 152 is disposed at the first filtering position. The third electrical contact portion 173 is not in contact with and electrically connected to the first electrical contact portion 170 when the first filter device 152 is disposed at the first retracted position. The fourth electrical contact portion 174 is in contact with and electrically connected to the second electrical contact portion 171 when the second filter device 153 is disposed at the second filtering position. The fourth electrical contact portion 174 is not in contact with and electrically connected to the second electrical contact portion 171 when the second filter device 153 is disposed at the second retracted position.

The first to fourth electrical contact portions 170, 171, 173, and 174 are formed of a conductive material such as copper, etc. The first to fourth electrical contact portions 170, 171, 173, and 174 are, for example, electrodes.

The detector 135 detects whether the first electrical contact portion 170 is electrically connected to the third electrical contact portion 173 and whether the second electrical contact portion 171 is electrically connected to the fourth electrical contact portion 174. The camera controller 110 determines whether the state is the first state or the second state based on the presence or absence of electrical connections of the first to fourth electrical contact portions 170, 171, 173, and 174 detected by the detector 135. Specifically, when the first electrical contact portion 170 and the third electrical contact portion 173 are electrically connected, the camera controller 110 determines that the state is the first state in which the first optical filter 130 is disposed at the first filtering position. When the second electrical contact portion 171 and the fourth electrical contact portion 174 are electrically connected, the camera controller 110 determines that the state is the second state in which the second optical filter 131 is disposed at the second filtering position.

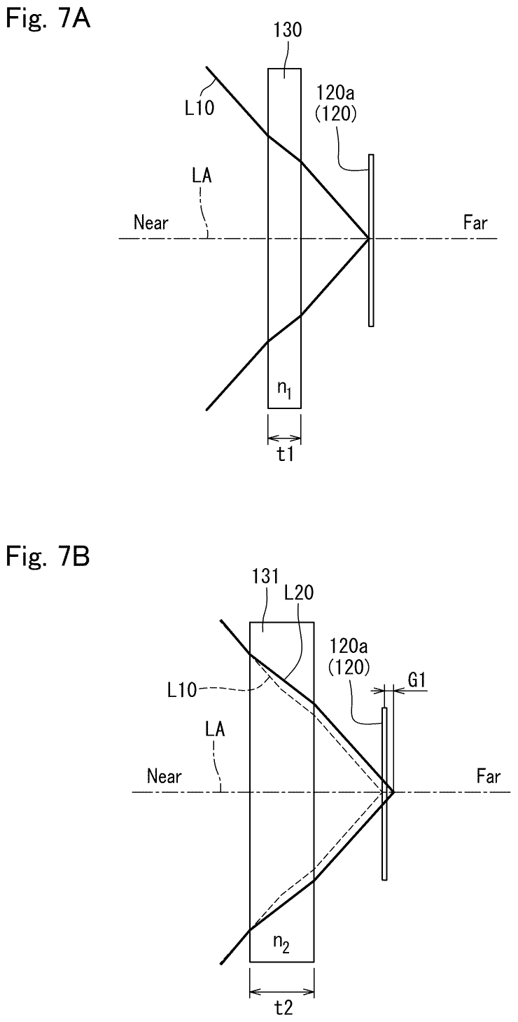

Next, the focus deviation caused by switching between the optical filters 130 and 131 will be described with reference to FIGS. 7A and 7B.

FIG. 7A is a diagrammatic view of the optical path in the first optical filter 130, and FIG. 7B is a diagrammatic view of the optical path in the second optical filter 131. Note that in FIGS. 7A and 7B, the first optical filter 130 is adjusted to a position where it is in focus during use.

As shown in FIG. 7A, light L10 transmitted through the first optical filter 130 is focused on the imaging surface 120a of the image sensor 120.

In this embodiment, the first optical filter 130 is made of clear glass, and the second optical filter 131 is an ND filter. That is, the refractive index n₂ and the thickness t₂ of the second optical filter 131 are greater than the refractive index n₁ and the thickness t₁ of the first optical filter 130.

When the first optical filter 130 is switched to the second optical filter 131, as shown in FIG. 7B, the refraction angle of the light L20 passing through the second optical filter 131 and the optical path within the filter become larger than those of the light L10, and the light L20 is focused at a position shifted from the imaging surface 120a of the image sensor 120. That is, by switching from the first optical filter 130 to the second optical filter 131, a focus deviation G1 occurs between the focusing positions of the light L10 and the light L20. Specifically, the focusing position of the light L20 shifts in the far direction from the focusing position of the light L10.

For example, when the focus deviation G1 occurs due to switching of an optical filter, the focus lens 250 is driven to eliminate the focus deviation G1.

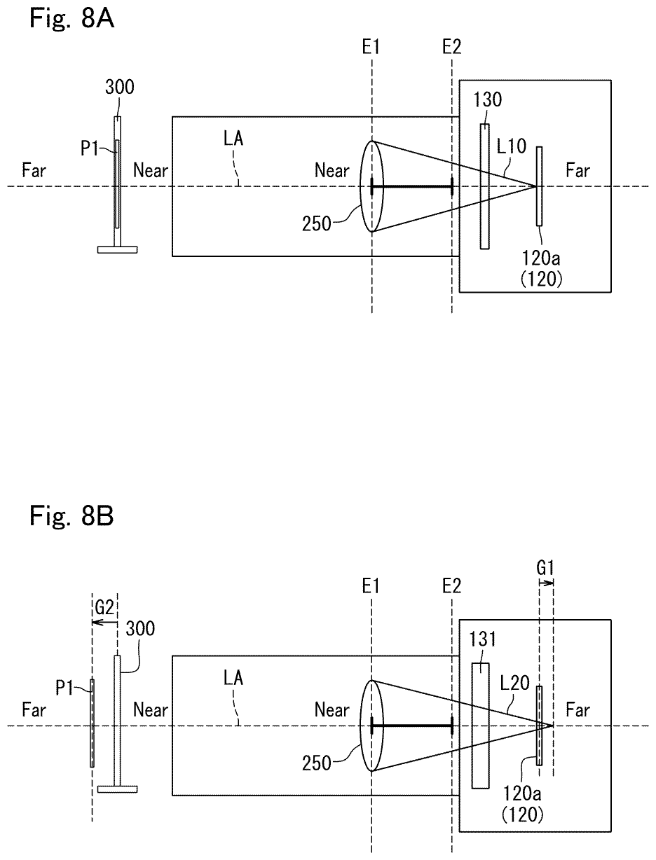

FIGS. 8A and 8B are diagrammatic views for explaining adjustment of the shooting distance attributable to the focus deviation G1 caused by switching the optical filter. In FIG. 8A and FIG. 8B, symbols E1 and E2 indicate the driving limits of the focus lens 250, symbol E1 indicates the driving end in the near direction, and symbol E2 indicates the driving end in the far direction.

As shown in FIG. 8A, when the first optical filter 130 is in use, the focus lens 250 is disposed at a drive end E1, and the focal position P1 is aligned with a subject 300.

When the filter is switched from the first optical filter 130 presenting in-focus state to the second optical filter 131, the focus deviation G1 occurs as shown in FIG. 8B. This causes the focus position P1 to shift from the subject 300. For example, the focus deviation G1 occurring in the far direction causes the focus position P1 to shift in the far direction from the subject 300. In other words, the focus deviation G1 causes a focus deviation G2.

In this case, the focus lens 250 is driven so as to eliminate the focus deviation G1 by an autofocus function or the like. However, when the focus lens 250 is disposed at the drive end E1, the focus lens 250 cannot be driven in the Near direction. Therefore, the focal position P1 cannot be aligned with the subject 300.

In this manner, when switching from the first optical filter 130 to the second optical filter 131, a range occurs in which the shooting distance cannot be adjusted. For this reason, in the imaging apparatus 10 disclosed herein, information regarding the shooting distance that can be set in response to switching of the light conditions using the optical filters 130 and 131 is displayed on the liquid crystal monitor 103. This notifies the user that there is a shooting distance that cannot be set in response to switching of the light conditions.

### (Operation)

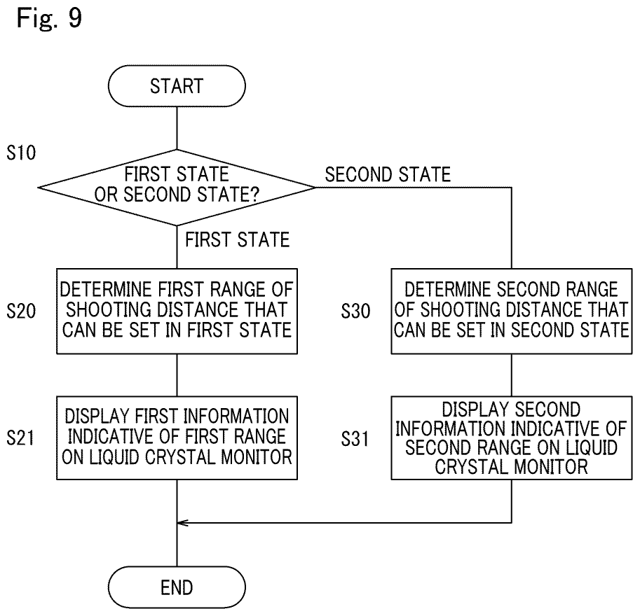

The operation of the imaging apparatus according to the first embodiment of the present disclosure, i.e., a method for controlling the imaging apparatus, will be described with reference to FIG. 9. FIG. 9 is a schematic flowchart of the method for controlling the imaging apparatus according to the first embodiment of the present disclosure.

The process shown in FIG. 9 starts, for example, when switching of the first optical filter 130 or the second optical filter 131 is performed.

As shown in FIG. 9, at step S10, the camera controller 110 determines whether the state is the first state or the second state. Specifically, the detector 135 detects whether the first optical filter 130 is disposed at the first filtering position or the second optical filter 131 is disposed at the second filtering position. The camera controller 110 determines whether the state is the first state or the second state based on the result detected by the detector 135.

If the state is the first state, the process proceeds to step S20. If the state is the second state, the process proceeds to step S30.

At step S20, the camera controller 110 determines the first range of the shooting distance that can be set in the first state. The first range is stored in the flash memory 111. The camera controller 110 obtains the first range from the flash memory 111 and determines it.

The first range is a range of shooting distances that can be set when capturing an image using the first optical filter 130. In this embodiment, since the first optical filter 130 is made of clear glass, the first range is determined to be, for example, a range of 0.1 to ∞ (infinity symbol).

At step S21, the camera controller 110 displays, on the liquid crystal monitor 103, the first information indicating the first range.

At step S30, the camera controller 110 determines the second range of the shooting distance that can be set in the second state. The second range is stored in the flash memory 111. The camera controller 110 obtains the second range from the flash memory 111 and determines it.

The second range is a range of shooting distances that can be set when capturing an image using the second optical filter 131. In this embodiment, since the second optical filter 131 is an ND filter, the second range is determined to be, for example, a range from 0.5 to ∞ (infinity symbol). When the second optical filter 131 is being used, the image cannot be focused at a shooting distance of less than 0.5.

At step S31, the camera controller 110 displays, on the liquid crystal monitor 103, second information indicating the second range.

In the control method, steps S20 and S30 are not essential steps. For example, step S21 or step S31 may be performed after step S10.

The first information and the second information include at least one of a numeral, a letter, a picture, and a bar related to the shooting distance.

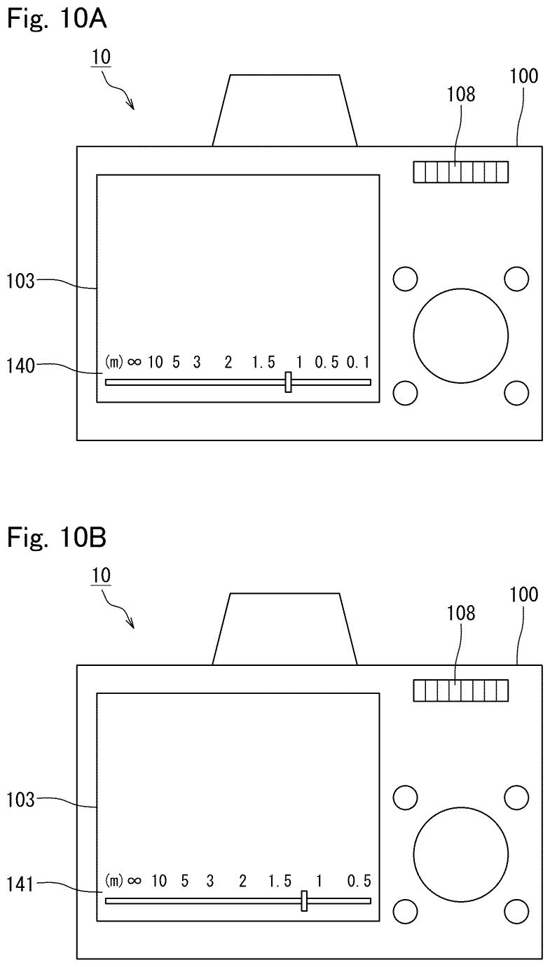

FIG. 10A is a diagrammatic view of an example of display on the liquid crystal monitor 103 in the first state, and FIG. 10B is a diagrammatic view of an example of display on the liquid crystal monitor 103 in the second state.

As shown in FIG. 10A, first information 140 includes bars, numerals, and letters indicating the first range of the shooting distance that can be set when using the first optical filter 130. In this embodiment, the first information 140 includes numerals and letters representing shooting distances of 0.1 to ∞ (infinity symbol) (m), and bars.

As shown in FIG. 10B, second information 141 includes bars, numerals, and letters indicating the second range of the shooting distance that can be set when using the second optical filter 131. In this embodiment, the second information 141 includes numerals and letters representing shooting distances of 0.5 to ∞ (infinity symbol) (m), and bars.

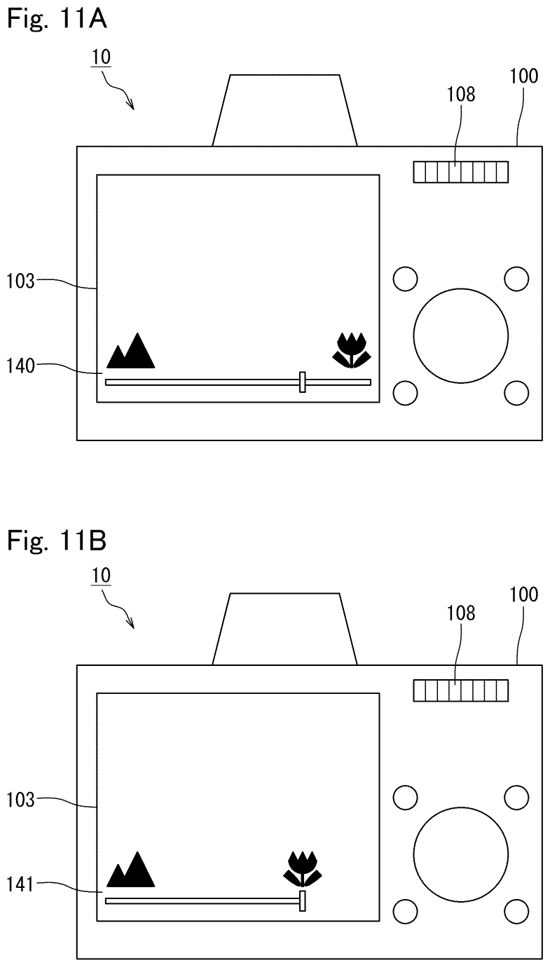

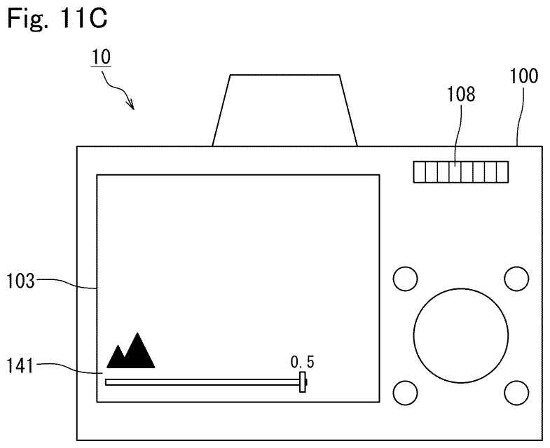

FIG. 11A is a diagrammatic view of another example of display on the liquid crystal monitor in the first state, FIG. 11B is a diagrammatic view of another example of the display on the Liquid crystal monitor in the second state, and FIG. 11C is a diagrammatic view of another example of the display on the Liquid crystal monitor in the second state.

As shown in FIGS. 11A and 11B, the first information 140 and the second information 141 may include a bar and a picture. For example, the picture is a picture indicating the upper and lower limits of the shooting distance.

As shown in FIG. 11C, the second marking 141 may include a bar, a numeral, and a picture. Similarly, the first marking 140 may include a bar, a numeral, and a picture.

### (Effect)

The imaging apparatus 10 according to the first embodiment of the present disclosure can achieve the following effects.

The imaging apparatus 10 of the present disclosure includes the image sensor (imaging element) 120, the switcher 134, the liquid crystal monitor (display device) 103, and the camera controller (processor) 110. The image sensor 120 has the imaging surface 120a on which light from a subject is incident. The switcher 134 switches the state of light incident on the imaging surface 120a between the first state and the second state different from the first state. The state is changed by the optical filters 130 and 131. The liquid crystal monitor 103 displays information. The camera controller 110 controls the image sensor 120, the switcher 134, and the liquid crystal monitor 103. The camera controller 110 determines whether the state is the first state or the second state. In response to determining that the state is the first state, the camera controller 110 controls the liquid crystal monitor 103 to display the first information 140 indicating the first range of the shooting distance that can be set in the first state. In response to determining that the state is the second state, the camera controller 110 controls the liquid crystal monitor 103 to display the second information 141 indicating the second range of the shooting distance that can be set in the second state.

With this configuration, information on the shooting distance that can be set according to the switching of the light state using the optical filters 130 and 131 can be displayed. The optical filters 130 and 131 may have different refractive indices and/or thicknesses. Therefore, switching the optical filters 130 and 131 may cause the focus deviation G1. In this case, if the focus lens 250 is disposed at the drive end E1, the shooting distance cannot be adjusted. The imaging apparatus 10 of the present disclosure can display the range in which the shooting distance can be adjusted on the liquid crystal monitor 103 according to the first state or the second state. This allows the user to easily grasp the shooting distance that can be set according to the first state or the second state.

The first information and the second information include at least one of a numeral, a letter, a picture, and a bar related to the shooting distance. With this configuration, the user can easily know the shooting distance range.

The optical filters include the first optical filter 130 and the second optical filter 131 having a refractive index or thickness different from that of the first optical filter 130. The first state is a state in which the state of light is changed by the first optical filter 130, and the second state is a state in which the state of light is changed by the second optical filter 131. With this configuration, it is possible to display information about the shooting distance that can be set in response to switching of the state of light using the optical filters 130 and 131.

Furthermore, by controlling the refractive index or thickness of the first optical filter 130 and the second optical filter 131, the direction of the focus deviation G1 can be controlled.

As an example, in the manufacturing process of the imaging apparatus 10, the first optical filter 130 may be disposed in front of the imaging surface 120a of the image sensor 120, and the back focus may be adjusted to match the imaging surface 120a. In this case, if the refractive index n₂ or the thickness t₂ of the second optical filter 131 is larger than the refractive index n₁ or the thickness t₁ of the first optical filter 130, the focus deviation G1 may occur in the far direction when switching from the first optical filter 130 to the second optical filter 131.

As another example, in the manufacturing process of the imaging apparatus 10, adjustment may be made so that the back focus is aligned with the imaging surface 120a in a state where the second optical filter 131 is disposed in front of the imaging surface 120a of the image sensor 120. In this case, if the refractive index n₂ or the thickness t₂ of the second optical filter 131 is larger than the refractive index n₁ or the thickness t₁ of the first optical filter 130, the focus deviation G1 can be generated in the near direction when switching from the second optical filter 131 to the first optical filter 130.

The switcher 134 includes a driver that moves the optical filters 130 and 131 between a filtering position and a retracted position. The filtering position is a position where the optical filters 130 and 131 are disposed in front of the imaging surface 120a of the image sensor 120, and light before reaching the imaging surface 120a passes through the optical filters 130 and 131. The retracted position is a position where the optical filters 130 and 131 are removed from the front of the imaging surface 120a. With this configuration, the first state and the second state can be switched by moving the optical filters 130 and 131 between the filtering position and the retracted position.

The imaging apparatus 10 includes the detector 135 that detects the first state and the second state. The camera controller 110 determines whether the state is the first state or the second state based on the result detected by the detector 135. With this configuration, the first state and the second state can be easily detected.

The control method, program, and computer-readable storage medium for an imaging apparatus according to the first embodiment of the present disclosure provide the same effects as those of the imaging apparatus 10 described above.

### Second Embodiment

An imaging apparatus according to a second embodiment of the present disclosure will be described.

In the second embodiment, differences from the first embodiment will be mainly described. In the second embodiment, the same or equivalent configurations as those in the first embodiment will be denoted by the same reference numerals. Also, in the second embodiment, descriptions that overlap with those in the first embodiment will be omitted.

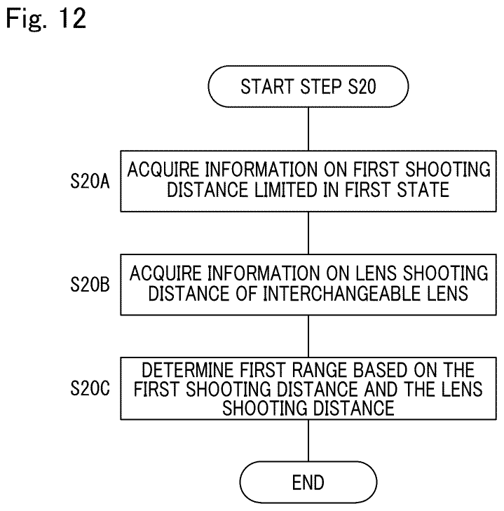

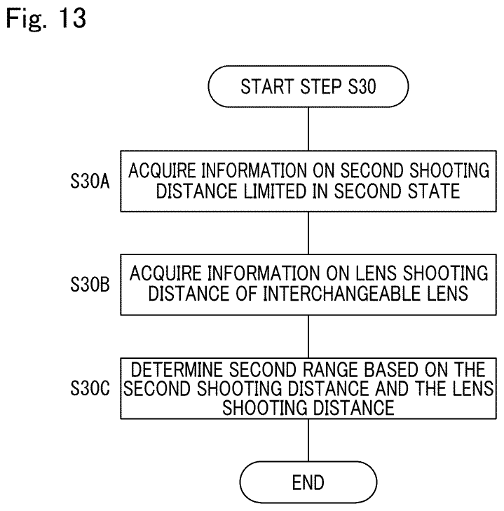

FIG. 12 is a flowchart of a process for determining the first range in a control method for an imaging apparatus according to the second embodiment of the present disclosure. FIG. 13 is a flowchart of a process for determining the second range in a control method for an imaging apparatus according to the second embodiment of the present disclosure.

The second embodiment differs from the first embodiment in that the first range and the second range are determined based on the shooting distances of the optical filters 130 and 131 and the lens shooting distance of the interchangeable lens 200.

FIG. 12 shows the process of step S20 for determining the first range. As shown in FIG. 12, step S20 includes steps S20A to S20C.

At step S20A, the camera controller 110 acquires information on a first shooting distance limited in the first state. The first shooting distance is a shooting distance limited by the first optical filter 130. For example, the information on the first shooting distance is stored in the flash memory 111 of the camera body 100. The camera controller 110 acquires the information on the first shooting distance from the flash memory 111.

At step S20B, the camera controller 110 acquires information on the lens shooting distance of the interchangeable lens 200. The lens shooting distance is a shooting distance limited by the interchangeable lens 200. For example, the information on the lens shooting distance is stored in the flash memory 212 of the interchangeable lens 200. The camera controller 110 acquires the information on the lens shooting distance from the flash memory 212.

At step S20C, the camera controller 110 determines the first range based on the first shooting distance and the lens shooting distance. For example, the camera controller 110 compares the first shooting distance with the lens shooting distance, and determines a shooting distance range where the first shooting distance and the lens shooting distance overlap as the first range. For example, when the first shooting distance is 0.1 to ∞ (infinity symbol) and the lens shooting distance is 1 to ∞ (infinity symbol), the first range is determined to be 1 to ∞ (infinity symbol).

FIG. 13 shows the process of step S30 for determining the second range. As shown in FIG. 13, step S30 includes steps S30A to S30C.

At step S30A, the camera controller 110 acquires information on a second shooting distance limited in the second state. The second shooting distance is a shooting distance limited by the second optical filter 131. For example, the information on the second shooting distance is stored in the flash memory 111 of the camera body 100. The camera controller 110 acquires the information on the second shooting distance from the flash memory 111.

At step S30B, the camera controller 110 acquires information about the lens shooting distance of the interchangeable lens 200. Step S30B is similar to step S20B, and therefore a description thereof will be omitted.

At step 30C, the camera controller 110 determines the second range based on the second shooting distance and the lens shooting distance. For example, the camera controller 110 compares the second shooting distance with the lens shooting distance, and determines the range of shooting distances that overlap the second shooting distance and the lens shooting distance as the second range. For example, if the second shooting distance is 2 to ∞ (infinity symbol) and the lens shooting distance is 1 to ∞ (infinity symbol), the second range is determined to be 2 to ∞ (infinity symbol).

In addition, if it is known in advance that the lens shooting distance is greater than the first shooting distance and the second shooting distance, the camera controller 110 may determine the first range or the second range based on the first shooting distance or the second shooting distance rather than based on the lens shooting distance.

### (Effect)

The imaging apparatus 10 according to the second embodiment of the present disclosure can achieve the following effects.

In the imaging apparatus 10 of the present disclosure, in response to determining that the state is the first state, the camera controller 110 determines the first range based on information on a first shooting distance limited in the first state. In response to determining that the state is the second state, the camera controller 110 determines the second range based on information on a second shooting distance limited in the second state. With this configuration, the range of shooting distances that can be set in response to switching of the light state using the optical filters 130 and 131 can be easily determined.

The camera controller 110 acquires information on the lens shooting distance of the attached interchangeable lens 200. The camera controller 110 determines the first range based on the first shooting distance and the lens shooting distance. The camera controller 110 determines the second range based on the second shooting distance and the lens shooting distance. With this configuration, it is possible to easily determine the range of shooting distances that can be set based on switching of the light state using the optical filters 130 and 131 and the lens shooting distance of the interchangeable lens 200.

### Third Embodiment

An imaging apparatus according to a third embodiment of the present disclosure will be described.

In the third embodiment, differences from the first embodiment will be mainly described. In the third embodiment, the same or equivalent configurations as those in the first embodiment will be denoted by the same reference numerals. Also, in the third embodiment, descriptions that overlap with those in the first embodiment will be omitted.

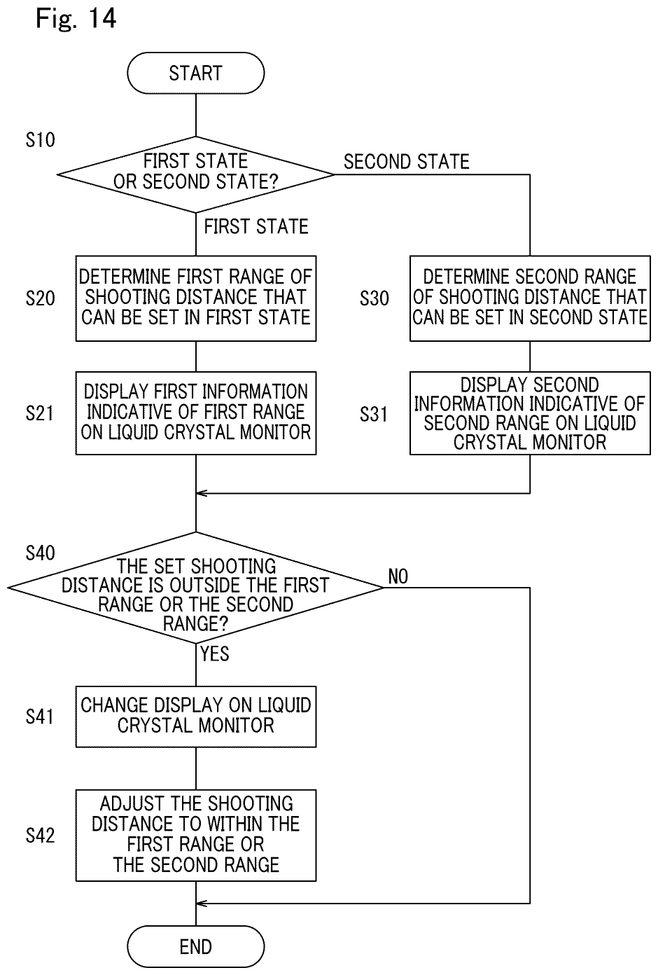

FIG. 14 is a schematic flowchart of a control method for an imaging apparatus according to the third embodiment of the present disclosure.

The third embodiment differs from the first embodiment in that the display on the liquid crystal monitor 103 is changed in response to determining that the set shooting distance is outside the first range or the second range.

As shown in FIG. 14, the method for controlling an image apparatus according to this embodiment includes steps S10 to S42. Steps S10 to S31 are the same as those in the first embodiment, and therefore a description thereof will be omitted.

At step S40, the camera controller 110 determines whether the set shooting distance is outside the first range or the second range. For example, the lens controller 210 of the interchangeable lens 200 acquires driving information of the focus lens driver 251. The lens controller 210 transmits the driving information to the camera controller 110. The camera controller 110 receives the driving information and calculates the set shooting distance based on the driving information. In the first state, the camera controller 110 determines whether the set shooting distance is outside the first range. In the second state, the camera controller 110 determines whether the set shooting distance is outside the second range.

In the first or second state, if the set shooting distance is outside the first or second range, the process proceeds to step S41. If the set shooting distance is not outside the first or second range, the process comes to an end.

At step S41, the camera controller 110 changes the display on the liquid crystal monitor 103. For example, the camera controller 110 displays a message on the screen of the liquid crystal monitor 103. The message includes content relating to the fact that the set shooting distance is outside the first range or the second range.

Alternatively, the camera controller 110 may change the screen of the liquid crystal monitor 103 to an image. For example, the image may be an image displayed in a single color such as black, white, red, yellow, or blue, or an image displayed in multiple colors. Alternatively, the image may be an image including a picture, photograph, or text indicating a warning.

At step S42, the camera controller 110 adjusts the shooting distance to within the first range or the second range. For example, the camera controller 110 transmits a command to the lens controller 210 to move the focus lens 250 in order to adjust the shooting distance by driving the focus lens 250. The lens controller 210 controls the focus lens driver 251 based on the command to drive the focus lens 250. As a result, in the first state, the shooting distance is adjusted to within the first range. In the second state, the shooting distance is adjusted to within the second range.

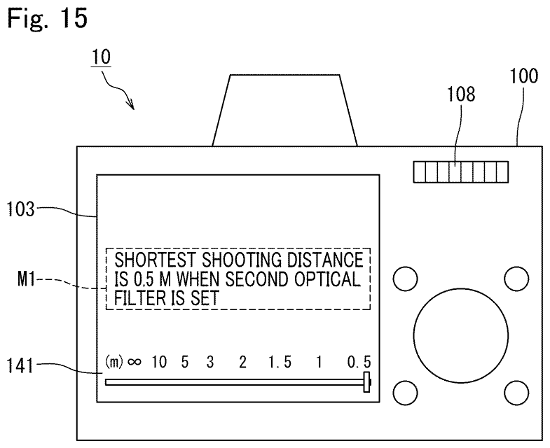

FIG. 15 is a diagrammatic view showing an example of a change in display on the liquid crystal monitor. FIG. 15 shows an example of the change in display on the liquid crystal monitor 103 in response to determining that the set shooting distance is outside the second range when the first state is switched to the second state.

As shown in FIG. 15, in response to determining that the set shooting distance is outside the second range, a message MI is displayed on the liquid crystal monitor 103 and the set shooting distance is adjusted to be within the second range.

In the example shown in FIG. 15, since the second range is 0.5 to ∞ (infinity symbol), the camera controller 110 displays a message M1 saying “The shortest shooting distance is 0.5 m when second optical filter is set”. The camera controller 110 also adjusts the shooting distance to the shortest shooting distance of 0.5 m.

Note that message M1 is not limited to the above example, and may be a message related to the fact that the set shooting distance is outside the first range or the second range. For example, message M1 may be “The shooting distance cannot be adjusted” or “The settable shooting distance range is 0.5 to ∞ (infinity symbol)”.

Furthermore, in the control method for an imaging apparatus according to this embodiment, step S42 is not an essential step, and for example, step S42 does not have to be performed.

### (Effect)

The imaging apparatus 10 according to the third embodiment of the present disclosure can achieve the following effects.

In the imaging apparatus 10 of the present disclosure, in response to determining that the set shooting distance is outside the first range in the first state, or in response to determining that the set shooting distance is outside the second range in the second state, the camera controller 110 changes the display on the liquid crystal monitor 103. With this configuration, it is possible to inform the user that the set shooting distance is outside the first range or the second range.

To change the display on the liquid crystal monitor 103, the camera controller 110 controls the liquid crystal monitor 103 to display a message M1. With this configuration, it is possible to easily inform the user that the set shooting distance is outside the first range or the second range.

In response to determining that the set shooting distance is outside the first range in the first state, the camera controller 110 adjusts the shooting distance to within the first range. Also, in response to determining that the set shooting distance is outside the second range in the second state, the camera controller 110 adjusts the shooting distance to within the second range. With this configuration, when the set shooting distance is outside the first range or the second range, the shooting distance can be automatically adjusted to within the first range or the second range.

As described above, the above-mentioned embodiment has been described as an example of the technology in the present disclosure. For this purpose, drawings and detailed description are provided. Therefore, among the components described in the drawings and detailed description, not only components essential for solving the problem but also components that are not essential for solving the problem in order to illustrate the above-mentioned technology may be included. Therefore, the fact that these non-essential components are described in the drawings or detailed description should not be used to immediately determine that these non-essential components are essential.

Furthermore, since the above-described embodiments are intended to illustrate the technology in the present disclosure, various modifications, substitutions, additions, omissions, and the like can be made within the scope of the claims or their equivalents.

Furthermore, the above-described embodiments may be implemented by an apparatus, a system, a method, a computer program, and a computer-readable storage medium, as well as combinations thereof.

In the above embodiment, the first optical filter 130 is clear glass and the second optical filter 131 is an ND filter, but the present disclosure is not limited to this. For example, the first and second optical filters 130 and 131 may be clear glass, an ND filter, an electronic filter, or the like.

In the above embodiment, an example in which the first optical filter 130 and the second optical filter 131 are filters that change the transmittance of light has been described, but the present disclosure is not limited thereto. The first optical filter 130 and the second optical filter 131 may be a filter that transmits only light in a specific vibration direction, a filter used to suppress false colors and moire, a filter that cuts ultraviolet or ultraviolet light, a filter used to emphasize a specific color, a filter used to emphasize a light source, or a filter used to blur light. For example, the first optical filter 130 and the second optical filter 131 may be a polarizing plate, an optical low-pass filter, a UV filter, an IR filter, a color filter, a cross filter, a soft focus filter, or the like.

In the above embodiment, an example in which the imaging apparatus 10 includes two optical filters 130 and 131 has been described, but the present disclosure is not limited thereto. The imaging apparatus 10 may include one or more optical filters. For example, the imaging apparatus 10 may include one ND filter, the first state may be a state in which light does not pass through the optical filter and is directly incident on the imaging surface 120a. The second state may be a state in which the ND filter is disposed at a filtering position. That is, the second state may be a state in which light passes through the ND filter and is incident on the imaging surface 120a. Alternatively, the imaging apparatus 10 may include three or more optical filters including clear glass, an ND filter, or an electronic filter.

In the above embodiment, an example has been described in which the switcher 134 is implemented by the rack-and-pinion mechanism of the first and second drivers 160 and 161, but the present disclosure is not limited to this. For example, the switcher 134 may be implemented by another driver. For example, the switcher 134 may switch the first optical filter 130 and the second optical filter 131 by moving them in the vertical or horizontal direction.

In the above embodiment, an example has been described in which the detector 135 detects the state based on the presence or absence of electrical connection between the first to fourth electrical contact portions 170, 171, 173, and 174. However, the present disclosure is not limited to this. For example, the detector 135 may detect the state by detecting the positions of the optical filters 130 and 131 using a push switch, a capacitance sensor, a magnetic sensor, or the like.

In the above embodiment, the camera controller 110 executes each process, but the present disclosure is not limited to this. For example, at least a part of the above-described processes may be executed by the lens controller 210.

In the above embodiment, an example of the interchangeable lens 200 has been described, but the present disclosure is not limited to this. For example, the imaging apparatus 10 may be a lens-integrated camera in which a lens unit and a camera body 100 are integrated together.

In the above embodiment, an example has been described in which the shooting distance is adjusted by driving the focus lens 250. However, the present disclosure is not limited to this. For example, the shooting distance may be adjusted by driving the image sensor 120 in the optical axis direction L1.

In the above embodiment, an example has been described in which the liquid crystal monitor 103 is disposed on the rear surface of the camera body 100, but the present disclosure is not limited to this. For example, the Liquid crystal monitor 103 may be disposed on the top surface and/or side surface of the camera body 100.

In the above embodiment, an example has been described in which the first range and the second range are stored in the flash memory 111 of the camera body 100, but the present disclosure is not limited to this. For example, the first filter device and the second filter device may each include a memory, and the memory may store the first range and the second range.

The following describes variants.

### (First Variant)

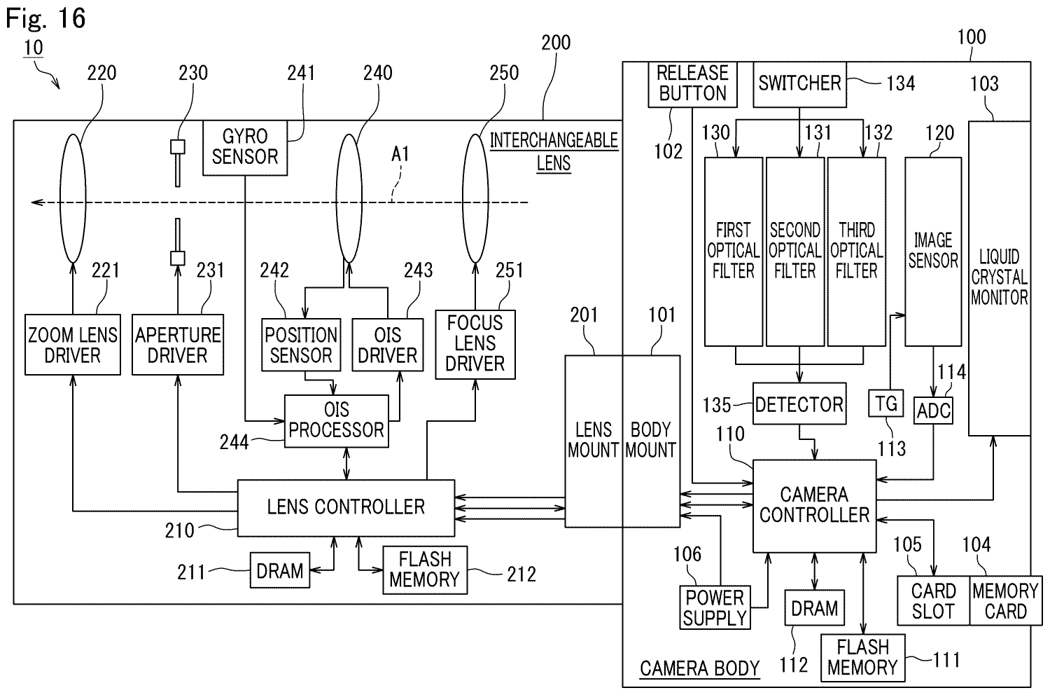

FIG. 16 is a schematic view for explaining an imaging apparatus according to a first variant.

As shown in FIG. 16, the imaging apparatus 10 according to the first variant may include three optical filters 130, 131, and 132. In the imaging apparatus 10 according to the first variant, the first to third light states can be switched using the first to third optical filters 130, 131, and 132. For example, the first optical filter 130 may be clear glass, the second optical filter 131 may be an ND filter with a first transmittance, and the third optical filter 132 may be an ND filter with a second transmittance. The first transmittance and the second transmittance are different transmittances.

In the first variant, the combination of the first to third optical filters 130, 131, and 132 is not limited to this.

### (Second Variant)

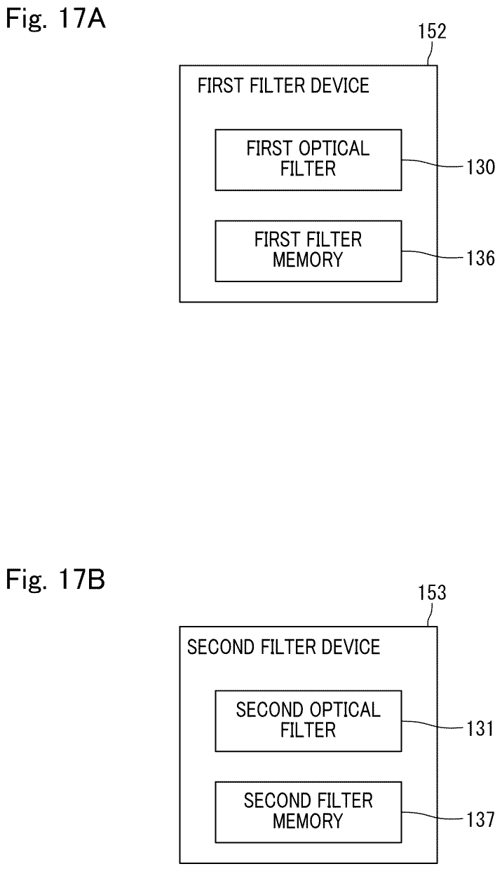

FIG. 17A is a block diagram showing a schematic configuration of a first filter device according to a second variant. FIG. 17B is a block diagram showing a schematic configuration of a second filter device according to the second variant.

As shown in FIG. 17A, a first filter device 152 according to the second variant may include a first filter memory 136 in addition to the first optical filter 130. The first filter memory 136 may store information on the first range of the shooting distance limited by the first optical filter 130.

As shown in FIG. 17B, the second filter device 153 according to the second variant may include a second filter memory 137 in addition to the second optical filter 131. The second filter memory 137 may store information on the second range of the shooting distance limited by the second optical filter 131.

In the first state, the camera controller 110 may obtain information of the first range from the first filter memory 136. Also, the camera controller 110 may obtain information of the second range from the second filter memory 137. In this case, the information of the first range and the second range may not be stored in the flash memory 111 of the camera body 100.

### (Third Variant)

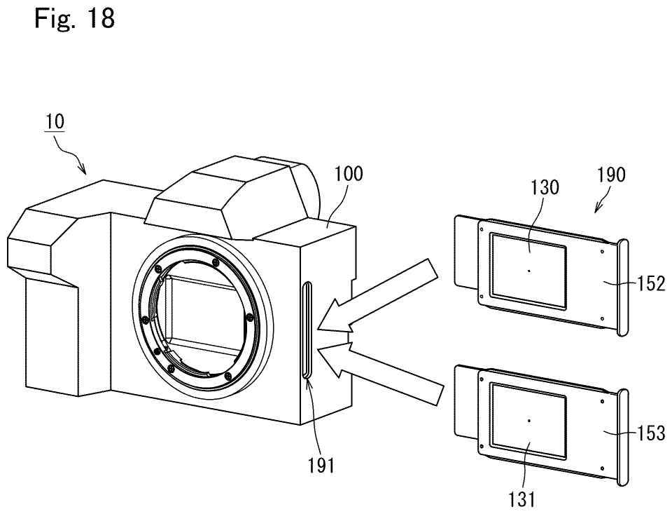

FIG. 18 is a schematic view for explaining an imaging apparatus according to a third variant.

As shown in FIG. 18, the imaging apparatus 10 according to the third variant is different from the first embodiment in that the switcher 134 includes an inserter 190 that inserts the first and second optical filters 130 and 131 into the filtering position. The other configurations in the third variant are similar to those of the imaging apparatus 10 according to the first embodiment.

In the inserter 190, the first and second optical filters 130 and 131 are inserted into the filtering position. In the inserter 190, the first and second filter devices 152 and 153 provided with the first and second optical filters 130 and 131 can be inserted into the filtering position.

The camera body 100 of the imaging apparatus 10 is provided with an insertion hole 191 into which the first filter device 152 or the second filter device 153 can be inserted. The first filter device 152 or the second filter device 153 is disposed in the imaging apparatus 10 through the insertion hole 191. As a result, the first optical filter 130 or the second optical filter 131 is disposed at the filtering position.

After the first filter device 152 and the second filter device 153 are inserted into the insertion hole 191, they can be removed from the insertion hole 191. This allows the first optical filter 130 and the second optical filter 131 to be placed in the filtering position and retracted from the filtering position.

In the third variant, either the first filter device 152 or the second filter device 153 is inserted into the insertion hole 191. Therefore, when the first filter device 152 is inserted into the insertion hole 191, the first optical filter 130 is disposed at the filtering position. When the second filter device 153 is inserted into the insertion hole 191, the second optical filter 131 is disposed at the filtering position. By inserting and removing the first filter device 152 and the second filter device 153, the first optical filter 130 and the second optical filter 131 are disposed at the same filtering position.

The inserter 190 may include a positioning component for positioning the first optical filter 130 or the second optical filter 131 at the filtering position. The positioning component includes, for example, a hole or a protrusion for positioning.

Furthermore, the inserter 190 may include rails or guides that allow the first filter device 152 and the second filter device 153 to slide.

In addition, in the inserter 190, the first optical filter 130 and the second optical filter 131 may be disposed at different filtering positions. For example, in the inserter 190, the first optical filter 130 may be inserted into the first filtering position, and the second optical filter 131 may be inserted into a second filtering position different from the first filtering position. The first filtering position may be farther from the imaging surface of the imaging element than the second filtering position. Specifically, the inserter 190 may be provided with a first insertion hole into which the first filter device 152 can be inserted, and a second insertion hole into which the second filter device 153 can be inserted. The second insertion hole is provided farther from the imaging surface of the imaging element than the first insertion hole.

The above-described embodiment and variants may be combined.

### (Summary of Embodiments)

(1) An imaging apparatus of the present disclosure includes: an imaging element having an imaging surface on which light from a subject is incident; a switcher switching a state of the light incident on the imaging surface between a first state and a second state different from the first state, the state being changed by an optical filter; a display device displaying information; and a processor controlling the imaging element, the switcher, and the display device. The processor determines whether the state is the first state or the second state. In response to determining that the state is the first state, the processor controls the display device to display first information indicative of a first range of a shooting distance that is capable of being set in the first state. In response to determining that the state is the second state, the processor controls the display device to display second information indicative of a second range of the shooting distance that is capable of being set in the second state.

(2) In the imaging apparatus of (1), the first information and the second information may include at least one of a numeral, a letter, a picture, and a bar related to the shooting distance.

(3) In the imaging apparatus of (1) or (2), the processor may change a display on the display device in response to determining that a set shooting distance is outside the first range in the first state or in response to determining that the set shooting distance is outside the second range in the second state.

(4) In the imaging apparatus of (3), the processor may change the display on the display device to display a message on the display.

(5) In the imaging apparatus of any one of (1) to (4), the processor may adjust the shooting distance to within the first range in response to determining that a set shooting distance is outside the first range in the first state. The processor may adjust the shooting distance to within the second range in response to determining that the set shooting distance is outside the second range in the second state.

(6) In the imaging apparatus of any one of (1) to (5), the optical filter may include: a first optical filter; and a second optical filter having a refractive index or a thickness different from that of the first optical filter. The first state may be a state in which the state of the light is changed by the first optical filter. The second state may be a state in which the state of the light is changed by the second optical filter.

(7) In the imaging apparatus of (6), the second optical filter may have a refractive index or a thickness greater than that of the first optical filter.

(8) In the imaging apparatus of any one of (1) to (7), in response to determining that the state is the first state, the processor may determine the first range based on information about first shooting distance limited in the first state. In response to determining that the state is the second state, the processor may determine the second range based on information about second shooting distance limited in the second state.

(9) The imaging apparatus of (8) may include a filter device including the optical filter and a filter memory that stores information about shooting distance limited by the optical filter. The optical filter may include: a first optical filter; and a second optical filter having a refractive index or a thickness different from that of the first optical filter. The first state may be a state in which the state of the light is changed by the first optical filter. The second state may be a state in which the state of the light is changed by the second optical filter. The filter memory may include: a first filter memory that stores information about the first shooting distance limited by the first optical filter; and a second filter memory that stores information about the second shooting distance limited by the second optical filter. The processor may acquire information about the first shooting distance from the first filter memory. The processor may acquire information about the second shooting distance from the second filter memory.

(10) In the imaging apparatus of (8) or (9), the processor may acquire information about lens shooting distance of a interchangeable lens. The processor may determine the first range based on the first shooting distance and the lens shooting distance. The processor may determine the second range based on the second shooting distance and the lens shooting distance.

(11) In the imaging apparatus of any one of (1) to (10), the switcher may include a driver that moves the optical filter between a filtering position and a retracted position. The filtering position may be a position where the optical filter is disposed in front of the imaging surface of the imaging element and where the light passes through the optical filter before reaching the imaging surface. The retracted position may be a position where the optical filter is out of front of the imaging surface.

(12) In the imaging apparatus of any one of (1) to (10), the switcher may include an inserter that inserts and removes the optical filter to and from a filtering position. The filtering position may be a position where the optical filter is disposed in front of the imaging surface of the imaging element and where the light passes through the optical filter before reaching the imaging surface.

(13) The imaging apparatus of any one of (1) to (12) may include a detector detecting the first state and the second state. The processor may determine whether the state is the first state or the second state based on a result detected by the detector.

(14) A method of the present disclosure is a method for controlling an imaging apparatus including an imaging element having an imaging surface on which light from a subject is incident, a switcher switching a state of the light incident on the imaging surface between a first state and a second state different from the first state, the state being changed by an optical filter, and a display device displaying information. The method includes: determining whether the state is the first state or the second state; in response to determining that the state is the first state, controlling the display device to display first information indicative of a first range of a shooting distance that is capable of being set in the first state; and in response to determining that the state is the second state, controlling the display device to display second information indicative of a second range of the shooting distance that is capable of being set in the second state.

(15) A program of the present disclosure causes a processor to execute the control method according to (14).

(16) A computer-readable storage medium of the present disclosure stores a program causing a processor to execute the control method according to (14).

What is claimed is:

1. An imaging apparatus comprising:
an imaging element having an imaging surface on which light from a subject is incident;
a switcher switching a state of the light incident on the imaging surface between a first state and a second state different from the first state, the state being changed by an optical filter;
a display device displaying information; and
a processor controlling the imaging element, the switcher, and the display device, wherein
the processor determines whether the state is the first state or the second state,
in response to determining that the state is the first state, the processor controls the display device to display first information indicative of a first range of a shooting distance that is capable of being set in the first state,
in response to determining that the state is the second state, the processor controls the display device to display second information indicative of a second range of the shooting distance that is capable of being set in the second state.

2. The imaging apparatus according to claim 1, wherein
the first information and the second information include at least one of a numeral, a letter, a picture, and a bar related to the shooting distance.

3. The imaging apparatus according to claim 1, wherein
the processor changes a display on the display device in response to determining that a set shooting distance is outside the first range in the first state or in response to determining that the set shooting distance is outside the second range in the second state.

4. The imaging apparatus according to claim 3, wherein
the processor changes the display on the display device to display a message on the display device.

5. The imaging apparatus according to claim 1, wherein
the processor adjusts the shooting distance to within the first range in response to determining that a set shooting distance is outside the first range in the first state, and wherein
the processor adjusts the shooting distance to within the second range in response to determining that the set shooting distance is outside the second range in the second state.

6. The imaging apparatus according to claim 1, wherein
the optical filter comprises:
a first optical filter; and
a second optical filter having a refractive index or a thickness different from that of the first optical filter, wherein
the first state is a state in which the state of the light is changed by the first optical filter, and wherein
the second state is a state in which the state of the light is changed by the second optical filter.

7. The imaging apparatus according to claim 6, wherein
the second optical filter has a refractive index or a thickness greater than that of the first optical filter.

8. The imaging apparatus according to claim 1, wherein
in response to determining that the state is the first state, the processor determines the first range based on information about first shooting distance limited in the first state, and wherein
in response to determining that the state is the second state, the processor determines the second range based on information about second shooting distance limited in the second state.

9. The imaging apparatus according to claim 8, further comprising:
a filter device including the optical filter and a filter memory that stores information about shooting distance limited by the optical filter, wherein
the optical filter includes:
a first optical filter; and
a second optical filter having a refractive index or a thickness different from that of the first optical filter, wherein
the first state is a state in which the state of the light is changed by the first optical filter, wherein
the second state is a state in which the state of the light is changed by the second optical filter, wherein
the filter memory includes:
a first filter memory that stores information about the first shooting distance limited by the first optical filter; and
a second filter memory that stores information about the second shooting distance limited by the second optical filter, wherein
the processor acquires information about the first shooting distance from the first filter memory, and wherein
the processor acquires information about the second shooting distance from the second filter memory.

10. The imaging apparatus according to claim 8, wherein
the processor acquires information about lens shooting distance of a interchangeable lens,
determines the first range based on the first shooting distance and the lens shooting distance, and
determines the second range based on the second shooting distance and the lens shooting distance.

11. The imaging apparatus according to claim 1, wherein
the switcher includes a driver that moves the optical filter between a filtering position and a retracted position,
the filtering position is a position where the optical filter is disposed in front of the imaging surface of the imaging element and where the light passes through the optical filter before reaching the imaging surface,
the retracted position is a position where the optical filter is out of front of the imaging surface.

12. The imaging apparatus according to claim 1, wherein
the switcher includes an inserter that inserts and removes the optical filter to and from a filtering position, and wherein
the filtering position is a position where the optical filter is disposed in front of the imaging surface of the imaging element and where the light passes through the optical filter before reaching the imaging surface.

13. The imaging apparatus according to claim 1, further comprising:
a detector detecting the first state and the second state, wherein
the processor determines whether the state is the first state or the second state based on a result detected by the detector.

14. A method for controlling an imaging apparatus including an imaging element having an imaging surface on which light from a subject is incident, a switcher switching a state of the light incident on the imaging surface between a first state and a second state different from the first state, the state being changed by an optical filter, and a display device displaying information, the method comprising:
determining whether the state is the first state or the second state;
in response to determining that the state is the first state, controlling the display device to display first information indicative of a first range of a shooting distance that is capable of being set in the first state; and
in response to determining that the state is the second state, controlling the display device to display second information indicative of a second range of the shooting distance that is capable of being set in the second state.

15. The method according to claim 14, wherein
the first information and the second information include at least one of a numeral, a letter, a picture, and a bar related to the shooting distance.

16. The method according to claim 14, further comprising:
changing a display on the display device in response to determining that a set shooting distance is outside the first range in the first state or in response to determining that the set shooting distance is outside the second range in the second state.

17. The method according to claim 16, wherein
the changing the display on the display device includes displaying a message on the display device.

18. The method according to claim 14, further comprising:
adjusting the shooting distance to within the first range in response to determining that a set shooting distance is outside the first range in the first state; and
adjusting the shooting distance to within the second range in response to determining that the set shooting distance is outside the second range in the second state.

19. The method according to claim 14, further comprising:
in response to determining that the state is the first state, determining the first range based on information about first shooting distance limited in the first state; and
in response to determining that the state is the second state, determining the second range based on information about second shooting distance limited in the second state.

20. A computer-readable storage medium that stores a program causing a processor to execute the control method according to claim 14.
